(19) United States
(12) Patent Application Publication
(10) Pub. No.: US 2014/0362676 A1
(43) Pub. Date: Dec. 11, 2014

(54) OPTICAL INFORMATION PROCESSING APPARATUS AND METHOD FOR CONTROLLING SAME

(71) Applicant: Electronics and Telecommunications Research Institute, Daejeon (KR)

(72) Inventors: Bong Ho Lee, Daejeon (KR); Jae Han Kim, Gwacheon-si Gyeonggi-do (KR); Gwang Soon Lee, Daejeon (KR); Tae One Kim, Daejeon (KR); Won Sik Cheong, Daejeon (KR); Nam Ho Hur, Daejeon (KR)

(21) Appl. No.: 14/366,171

(22) PCT Filed: Dec. 27, 2012
(86) PCT No.: PCT/KR2012/011625

§ 371 Date: Jun. 17, 2014

(30) Foreign Application Priority Data
Dec. 28, 2011 (KR) 10-2011-0144142
Dec. 27, 2012 (KR) 10-2012-0155024

(51) Int. Cl. G11B 7/095; G02B 27/28; G11B 7/13; G01B 11/14

(52) U.S. Cl. CPC G11B 7/0956; G01B 11/14; G02B 27/283; G11B 7/13
USPC 369/47.49

(57) ABSTRACT

The present invention relates to an optical information processing apparatus and to a method for controlling same. Provided is an optical information processing apparatus and a method for controlling same, the optical information processing apparatus comprising: a light source for irradiating light; an optical modulator for modulating the light irradiated from the light source; an optical system for collecting the light modulated by the optical modulator and enabling the modulated light to be incident to an optical medium; a stage on which the optical medium is placed; an optical detection unit for detecting the pattern of the light reflected from the optical medium; and a control unit for analyzing the pattern of the light detected by the optical detection unit so as to control the optical system and the location of the stage.

### CROSS-REFERENCE TO RELATED APPLICATIONS

This application claims the benefit of priority of Korean Patent Application No. 10-2011-0144142 filed on Dec. 28, 2011 and Korean Patent Application No. 10-2012-0155024 filed on Dec. 27, 2012, all of which are incorporated by reference in its entirety herein.

### TECHNICAL FIELD

The present invention relates to an optical information processing apparatus and a method for controlling the same, and more particularly, to an optical information processing apparatus which writes information on an optical medium or reads the information written on the optical medium by irradiating light onto the optical medium, and a method for controlling the same.

### BACKGROUND ART

In recent years, the research and development of optical information processing apparatuses such as a digital versatile disc (DVD), a high definition DVD (HD-DVD), a blu-ray disc (BD), a near-field optical information processing apparatus, and a holographic optical information processing apparatus, have been actively pursued.

Among them, the optical information processing apparatus using holography operates in such a manner as to write information on an optical medium or reproduce the information written on the optical medium by irradiating focused light on an optical medium made of a photosensitive material such as photopolymer and inducing a polymerization reaction.

In order to such an optical information processing apparatus to operate normally, optical characteristics, such as the focal position, intensity, and irradiation angle of the focused light irradiated on the optical medium, need to conform to predetermined criteria. Accordingly, a variety of techniques for determining whether such focused light is properly irradiated onto an optical medium are being suggested.

However, a conventional technique for analyzing the characteristics of focused light is carried out by acquiring and analyzing an image of focused light irradiated from a side of an optical medium or an image of focused light irradiated from the rear of the optical medium, thus making it difficult to accurately detect focused light being irradiated onto the optical medium.

### DISCLOSURE

### Technical Problem

The present invention has been made in an effort to solve the above-mentioned problem and to provide an optical information processing apparatus which can accurately measure information on a pattern of focused light by detecting a pattern of focused light irradiated on an optical medium in the direction of irradiation of focused light onto the optical medium, and a method for controlling the same.

The above-mentioned object of the present invention is accomplished by an optical information processing apparatus including: a light source for irradiating light; an light modulator for modulating the light irradiated from the light source; an optical system for focusing the light modulated by the light modulator and allowing the focused light to be incident on an optical medium; a stage where the optical medium is situated; a light detector for detecting a pattern of light reflected on the optical medium; and a controller that analyzes the light pattern detected by the light detector and controls the position of the optical system or the stage.

The light detector detects light patterns at first and second positions, and the controller controls the position of the optical system or the stage by comparing the positions, sizes, or distributions of the light patterns at the first and second positions. The second position refers to a position of the optical system shifted from the first position by a predetermined distance or a position of the stage shifted from the first position by a predetermined distance. In one example, the second position may correspond to a position of the stage spaced apart from the first position by a predetermined distance in a light travel direction.

If the center of the light pattern at the first and the center of the light pattern at the second position, detected by the light detector, are identical, the controller may determine that the stage is properly aligned along the optical axis. Also, the control may analyze the positions of the centers of the light patterns at the first and second positions detected by the light detector and an amount of change in the position of a given feature point between the patterns to determine whether the stage is tilted or not.

The optical information processing apparatus may include: a first position adjustment unit for controlling the position of at least one of a plurality of optical elements of the optical system; and a second position adjustment unit for adjusting the angle of slope of the stage.

The controller may control the first position adjustment unit or the second position adjustment unit to control at least one of the focal position, spot size, irradiation angle, and intensity distribution of light irradiated onto the optical medium.

The optical information processing apparatus may further include: a first polarizing beam splitter that reflects light incident from the light source in the direction of the light modulator and passes light incident from the light modulator therethrough in the direction of the optical system; and a second polarizing beam splitter that passes light incident onto the optical medium therethrough and reflects light reflected and incident from the optical medium in the direction of the light detector.

The above-mentioned object of the present invention is accomplished by a method for controlling an optical information processing apparatus, the method including the steps of: irradiating light modulated through a light modulator onto an optical medium through an optical system; detecting a pattern of light reflected from the optical medium; analyzing the light pattern detected in the step of detecting a light pattern; and adjusting the position of the optical system or the optical medium based on information obtained in the analysis step.

The detection of a light pattern may include: a first detection step of detecting a pattern of light reflected from the optical medium at a first position; and a second detection step of detecting a pattern of light reflected from the optical medium at a second position, wherein the position of the optical medium or the position of one of a plurality of elements is respectively different at the first position and the second position.

In one example, in the second detection step, the optical medium may be positioned, shifted from the position of the first detection step by a predetermined distance in the light travel direction.

In the analysis step, if the center of the light pattern at the first position detected in the first detection step and the center of the light pattern at the second position detected in the second detection, are identical, the optical medium may be determined as being properly aligned along the optical axis.

Also, in the analysis step, the positions of the centers of the light patterns at the first and second positions detected in the first and second detection steps and an amount of change in the position of a given feature point between the patterns may be analyzed to determine whether the optical medium is tilted or not.

Further, in the position adjustment step, the position of the optical system or the optical medium may be adjusted to control at least one of the focal position, spot size, irradiation angle, and intensity distribution of light irradiated onto the optical medium.

In the position adjustment step, based on the information obtained in the analysis step, the position of at least one of a plurality of optical elements of the optical system may be controlled, or the angle of slope of the stage where the optical medium is situated may be adjusted.

### Technical Solution

### Advantageous Effects

According to the present invention, accurate information can be obtained because the pattern of focused light on the optical medium can be measured in the direction of irradiation of focused light.

Furthermore, the occurrence of erroneous operation is minimized by adjusting the position of each component of the optical information processing apparatus based on information on the measured pattern of focused light.

### DESCRIPTION OF DRAWINGS

FIG. 1 is a block diagram showing the configuration of an optical information processing apparatus according to an exemplary embodiment of the present invention;

FIG. 2 is a block diagram showing an example of light irradiation on an optical medium when the optical medium of FIG. 1 is shifted;

FIG. 3 is a top plan view showing light patterns detected through an light detector at respective positions of FIG. 2;

FIG. 4 is a block diagram showing another example of light irradiation on the optical medium when the optical medium of FIG. 1 is shifted;

FIG. 5 is a top plan view showing light patterns detected through an light detector at respective positions of FIG. 4;

FIG. 6 is a top plan view showing light patterns according to wavelength in FIG. 1;

FIG. 7 is a top plan view showing the irradiation of reference light in FIG. 1;

FIG. 8 is a cross-sectional view showing cross-section of irradiation of reference light and cross-sections of irradiation on the optical medium of FIG. 7;

FIG. 9 is a sequential chart showing a method for controlling the optical information processing apparatus according to this exemplary embodiment; and

FIG. 10 is a sequential chart showing another method for controlling the optical information processing apparatus according to this exemplary embodiment.

### BEST MODE

### Mode for Invention

Hereinafter, an optical information processing apparatus and a method for controlling the same according to an exemplary embodiment of the present invention will be described with reference to the drawings. A description of the positional relationship between the components will now be made basically with reference to the drawings. In the drawings, structures of the invention may be simplified or exaggerated for clarity. Accordingly, the present invention is not limited to this exemplary embodiment, but instead various kinds of devices may be added, changed, or deleted.

Although this exemplary embodiment will be described with respect to a holographic optical information processing apparatus capable of writing information on an optical medium with information written thereon, it is to be noted that the present invention is not limited to this exemplary embodiment and is applicable to a variety of optical information processing apparatuses including an apparatus for reproducing information on an optical medium by light irradiation.

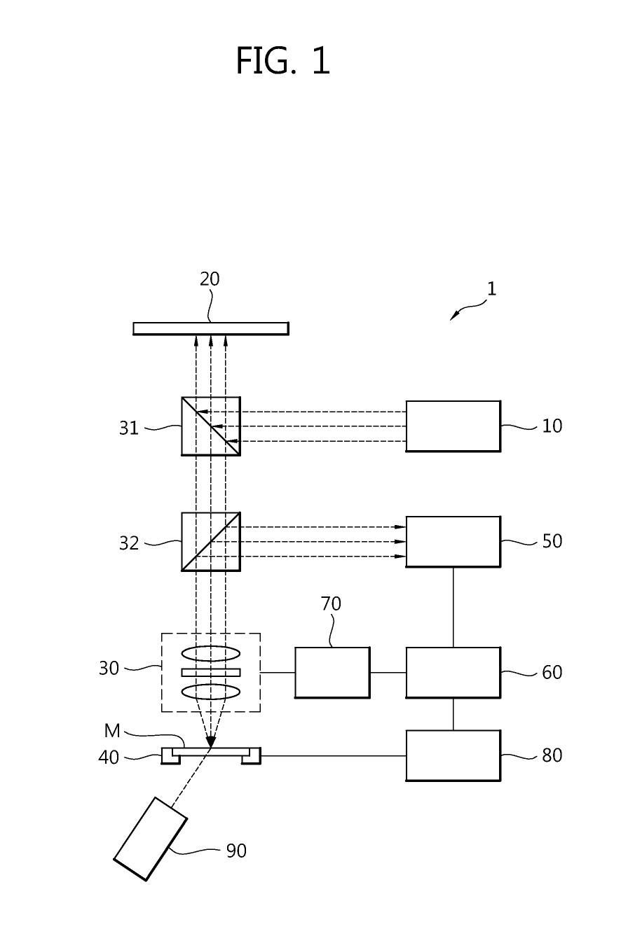

FIG. 1 is a block diagram showing the configuration of an optical information processing apparatus according to an exemplary embodiment of the present invention. As shown in FIG. 1, the optical information processing apparatus 1 according to this exemplary embodiment includes a light source 10, an light modulator 20 for modulating light incident from the light source, an optical system 30 for focusing the modulated light to be incident in the direction of the optical medium, a stage 40 where the optical medium M is situated, an light detector 50 for detecting a light pattern reflected from the optical medium, and a controller 60 for controlling the position of the optical system or optical medium by analyzing the detected light pattern. Hereinafter, each of the components will be described in detail with reference to the drawings.

The light source 10 produces light used to write or reproduce information on the optical medium M. The light source 10 can use light, such as laser, having a coherent property. While the light source 10 may be configured to produce a monochromatic light beam according to an embodiment, it may be configured to produce a plurality of light beams having different wavelengths according to this exemplary embodiment. In this exemplary embodiment, the light source 10 is configured to generate a red laser beam with a wavelength of 635 to 660 nm, a green laser beam with a wavelength of 525 to 540 nm, and a red laser beam with a wavelength of 420 to 473 nm.

Light generated from the light source 10 is reflected by a first polarizing beam splitter (PBS) 31 and incident on the light modulator. The first polarizing beam splitter 31 has an optical characteristic of reflecting a S-wave polarized light and passing a P-wave polarized light therethrough. Although not specifically shown in FIG. 1, the light generated from the light source 10 may be converted into S-wave light by an optical element such as a half-wavelength plate (not shown), and then irradiated onto the first polarizing beam splitter 31.

The light thusly generated from the light source is irradiated onto the light modulator 20. The light modulator 20 is a component for modulating incident light, and, in this exemplary embodiment, may be configured by using an LCoS (liquid crystal on silicon) device. Accordingly, if the light modulator 20 is normally driven, incident polarized light may be reflected with a different polarization property. In this exemplary embodiment, as the light incident from the light source 10 is reflected by the light modulator 20, its polarization property is converted from S-wave polarization to P-wave polarization.

Although the light modulator of this exemplary embodiment uses an incident light reflection structure, this is merely an example, and a transmissive light modulator for modulating light while transmitting incident light therethrough may be employed. Also, in the case that the light modulator is used for an apparatus for writing given information on an optical medium, information to be written may be included in the light incident form the light source so as to be irradiated in the direction of the optical medium.

The light reflected from the light modulator 20 travels in the direction of the first polarizing beam splitter 31 and a second polarizing beam splitter 32. Like the first polarizing beam splitter 31, the second polarizing beam splitter 32 passes P-waves therethrough and reflects S-waves. Therefore, the light modulated into P-wave light by the light modulator 20 passes through the first polarizing beam splitter 31 and the second polarizing beam splitter 32, and is incident in the direction of the optical system 30.

Here, the optical system 30 forms a light travel path, and includes a plurality of optical elements arranged in an optically axial direction. The plurality of optical elements are configured to focus light incident from the light modulator 20. The light having passed through the optical system 30 may be irradiated, focused on the optical medium M.

The optical system 30 may be configured such that the entire optical system or at least one of the plurality of optical elements of the optical system is movably provided to adjust the focal length, irradiation area, and distribution of the light irradiated on the optical medium M.

Specifically, the optical information processing apparatus 1 according to this exemplary embodiment may include a first position adjustment unit 70 for adjusting the position of the optical system or at least one of the plurality of optical elements. The first position adjustment unit 70 may be a separate component placed adjacent to the optical system or a component incorporated in the optical system. Accordingly, the first position adjustment unit 70 can change the characteristics of the light irradiated on the optical medium M by controlling the position of the entire optical system or at least some optical elements of the optical system in response to a control signal from the controller 60.

The stage 40 is a component where the optical medium M is situated, and arranged on the other side of the light modulator 20 with respect to the optical system 30. The stage 40 may be configured in various forms depending on the type of the optical medium M and the irradiation direction of light, and a detailed description thereof will be omitted. Therefore, the position of the optical medium M is determined by the stage 40, and light focused through the optical system 30 may be irradiated onto the optical medium M to write information thereon, or may be reflected on the optical medium M to obtain stored information.

The optical information processing apparatus 1 according to this exemplary embodiment may further include a second position adjustment unit 80 for adjusting the position of the optical medium M situated at the stage 40. The second position adjustment unit 80 may be a separate component placed adjacent to the stage or a structure incorporated in the stage. The second position adjustment unit 80 can move the optical medium M in a horizontal or vertical direction, or adjust the slope of the optical medium M situated at the stage. Accordingly, the second position adjustment unit 80 is able to control the position or slope of the optical medium M in response to a control signal from the controller 60.

The light focused and irradiated in the direction of the optical medium M is reflected on the optical medium M. The polarization property of the reflected light is maintained due to diffused reflection on the optical medium. For this reason, the reflected light may include both P-wave light and S-wave light.

The light reflected on the optical medium M travels in the opposite direction to that of the path of light incident in the direction of the optical medium M. Accordingly, the reflected light becomes unfocused as it passes through the optical system 30, and reaches the second polarizing beam splitter 32. Of these lights, the S-wave light may be reflected by the second polarizing beam splitter 32, and irradiated onto the light detector 50 provided at one side.

The light detector 50 is a component for detecting light reflected from the optical medium M, and may be an image pickup element such as a CCD (Charge Coupled Device) or a CMOS (Complementary Metal Oxide Semiconductor). Accordingly, the light detector 50 is capable of detecting a light pattern reflected from the optical medium M by detecting light forming an image on the surface of the CCD or CMOS. The light pattern refers to a pattern of light forming an image on the light detector 50, and may represent various characteristics depending on the position, shape, size, and light distribution of the image. Accordingly, it is possible to find out the form of focused light irradiated on the optical medium by detecting a light pattern reflected from the optical medium M by the light detector 50.

Therefore, the controller 60 may analyze whether light is properly irradiated onto the optical medium M by analyzing the light pattern detected by the light detector 50, and adjust the position of the optical system 30 or optical medium M according to an analysis result by the first position adjustment unit 70 and the second position adjustment unit 80 so that light is properly irradiated onto the optical medium.

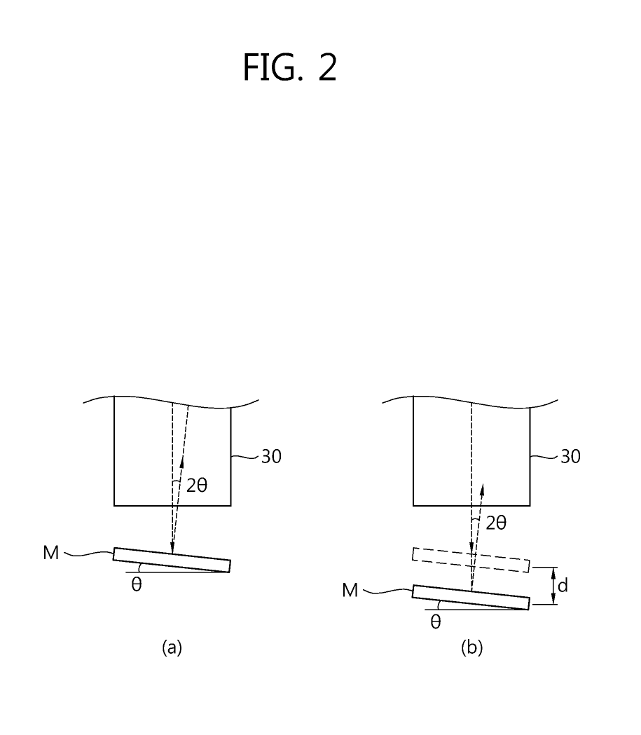

Hereinafter, an example in which the controller performs control by analyzing the light pattern detected by the light detector will be described in detail with reference to FIGS. 2 to 8.

As discussed above, the controller 60 analyzes the characteristics of light irradiated onto the optical medium M by using the light pattern detected by the light detector 50. Here, the light detector 50 may detect patterns of light reflected when the optical medium M is placed at different positions. Also, the controller 60 can analyze information on the characteristics of light irradiated onto the optical medium; more specifically, information on the focal position, spot size, irradiation angle, intensity distribution, etc of light by using a plurality of light patterns detected in the above manner.

Especially, when the optical medium M is shifted along the optical axis vertically (with respect to FIG. 1), information such as the focal position of light having passed through the optical system and the slope of the optical medium can be checked by analyzing patterns of light before and after the shift.

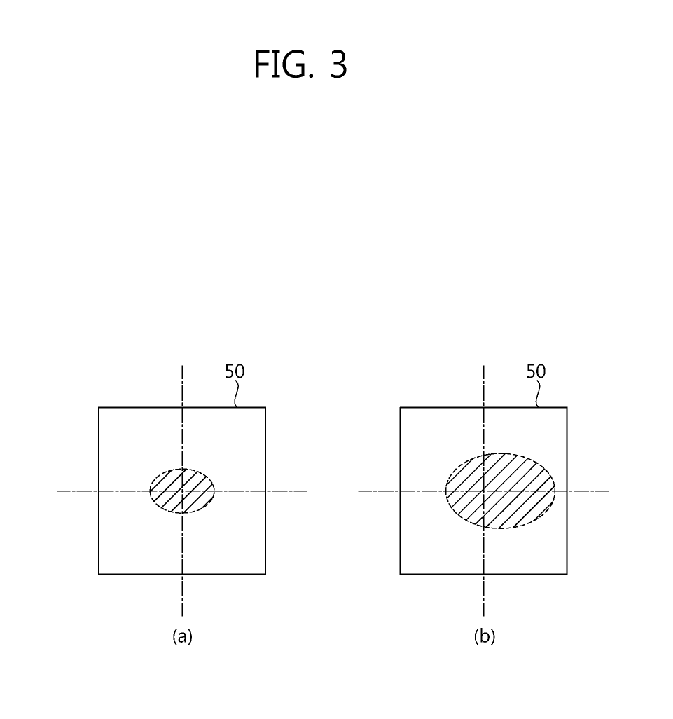

FIG. 2 is a block diagram showing an example of light irradiation on an optical medium when the optical medium of FIG. 1 is shifted. FIG. 3 is a top plan view showing light patterns detected through an light detector at respective positions of FIG. 2.

a of FIG. 2 illustrates the optical medium M placed at the first position. As shown in a of FIG. 2, the optical medium M is positioned inclined at a predetermined angle θ. Accordingly, even when focused light is vertically incident, the focused light travels obliquely at a predetermined angle of θ2 if it is reflected by the optical medium.

Accordingly, as shown in a of FIG. 3, the light pattern forming an image on the surface of the light detector 50 is tilted to one side from the center of the light detector 50. When a circular light is irradiated, it extends in a particular direction and forms an image in the shape of an ellipse, as shown in a of FIG. 3.

b of FIG. 2 illustrates the optical medium M shifted to the second position by controlling the second position adjustment unit 80 by the controller 50. The second position corresponds to a position spaced apart from the first position by a predetermined distance d along the optical axis direction (vertical direction). In this exemplary embodiment, the second position is farther from the end of the optical system 30; however, this is merely an example, and the second position may be shifted upward to get closer to the end of the optical system.

Even when the position of the optical medium M is shifted as shown in b of FIG. 2, the slope of the optical medium remains the same. Accordingly, if focused light is vertically incident from the optical system 30, reflected light travels obliquely at 2θ in a vertical direction, as shown in a of FIG. 2. However, the light travel path between the optical medium M and the optical system 30 becomes longer, as compared to a of FIG. 2. Therefore, as shown in b of FIG. 3, the light pattern forming an image on the light detector 50 has the same shape as the pattern a of FIG. 3, but is tilted to one side and enlarged compared to the pattern a of FIG. 3.

Accordingly, the controller 60 can find out that the optical medium M is positioned inclined, by analyzing the first pattern (pattern a of FIG. 3) and the second pattern (pattern b of FIG. 3), obtained when the optical medium M is at the first position. Also, the controller 60 can calculate the direction and angle of inclination of the optical medium by comparing a normal light pattern, the first pattern, and the second pattern with one another (for example, if the light detector 50 is designed to detect a circular light pattern, as in normal cases, the angle of inclination can be calculated by using the ratio of the long axis and short axis of the first pattern or second pattern). As a consequence, the controller 60 is able to position the optical medium M vertically to the optical axis by controlling the second position adjustment unit 80.

If the optical medium is tilted, however, a light pattern, which is longer in one direction than the normal light pattern, is detected to be tilted to one side from the center of the light detector 50. Accordingly, although the slope of the optical medium can be estimated without comparing the patterns obtained at the two positions to each other, as described above, it will be unclear whether such a phenomenon results from a defect in the position of the optical system or from a defect in the position of the optical medium. Therefore, it will be more accurate by analyzing the aligned state of the optical medium by using a plurality of light patterns detected at different positions.

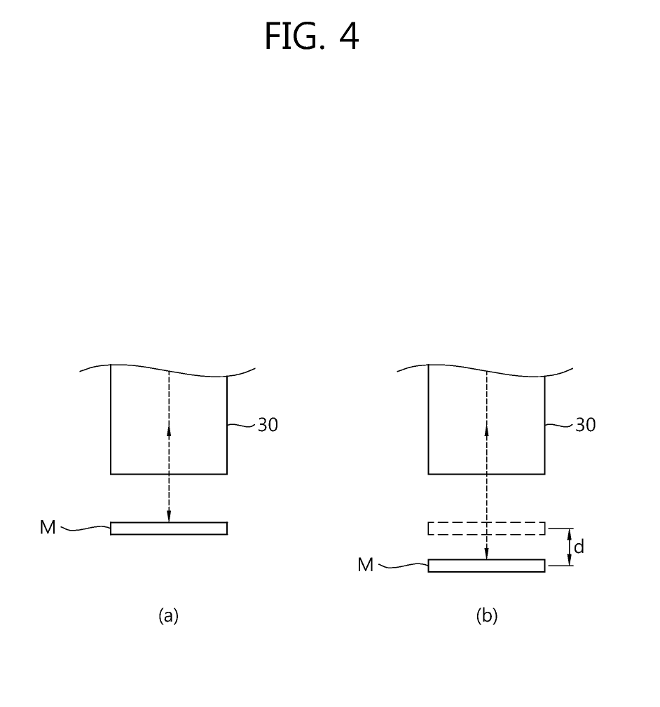

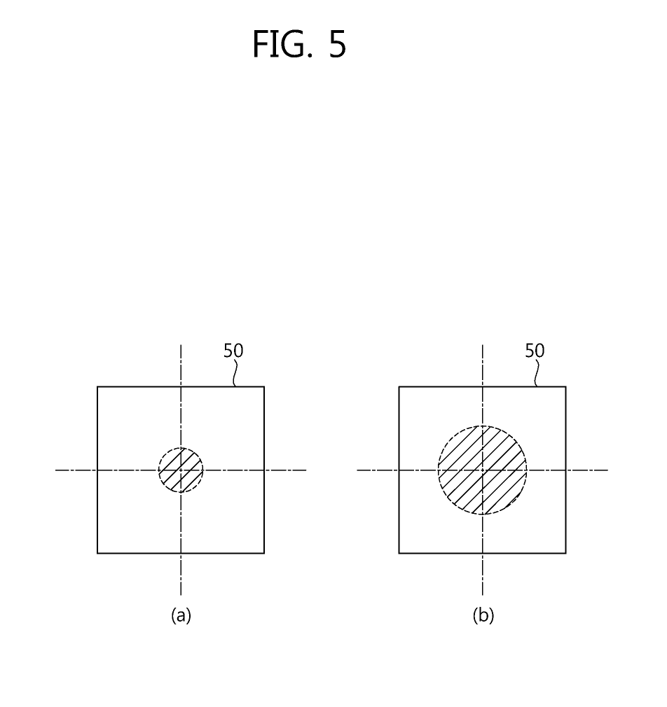

FIG. 4 is a block diagram showing another example of light irradiation on an optical medium when the optical medium of FIG. 1 is shifted. FIG. 5 is a top plan view showing light patterns detected through an light detector at respective positions of FIG. 4.

a of FIG. 4 illustrates the optical medium M placed at the first position, and b of FIG. 4 illustrates the optical medium M placed at the second position. The optical medium M of FIG. 4 is positioned vertically parallel to the optical axis, without being inclined, as compared to the optical medium M of FIG. 2.

Accordingly, as shown in a of FIG. 5, the light pattern detected when the optical medium M is at the first position is circular at the center of the light detector 50. Also, as shown in b of FIG. 5, the light pattern detected when the optical medium M is at the second position may be circular at the center of the light detector 50, and enlarged compared to a of FIG. 5.

Therefore, by analyzing the first pattern (a of FIG. 5) and the second pattern (b of FIG. 5), the controller determines the horizontal level of the optical medium and whether the optical system is properly aligned along the optical axis, only when the two patterns are identical in shape and center position and differ in size, and therefore controls focal position and spot size.

Here, focal position and spot size can be controlled by making a predetermined light pattern and a light pattern detected by the light detector equal in size. To this end, the controller 60 can shift the position of an optical element (e.g., object lens) of the optical system along the optical axis by controlling the first position adjustment unit 70, or shift the position of the optical medium M in a vertical direction by controlling the second position adjustment unit 80. If a light pattern detected at each position is identical to the predetermined light pattern, it is determined that their focal position and spot size are equal, thereby completing the setting.

According to this exemplary embodiment, the controller 60 can align the positions of the optical system and the optical medium based on information on the light patterns detected by the light detector 50. While the foregoing description has been given only on some application examples, the irradiation angle and intensity distribution of light, as well as the focal position and spot size of light, can be precisely compensated in various ways, based on the position (center position or feature points on the long axis and short axis), size, shape, and intensity distribution of a light pattern obtained by the light detector.

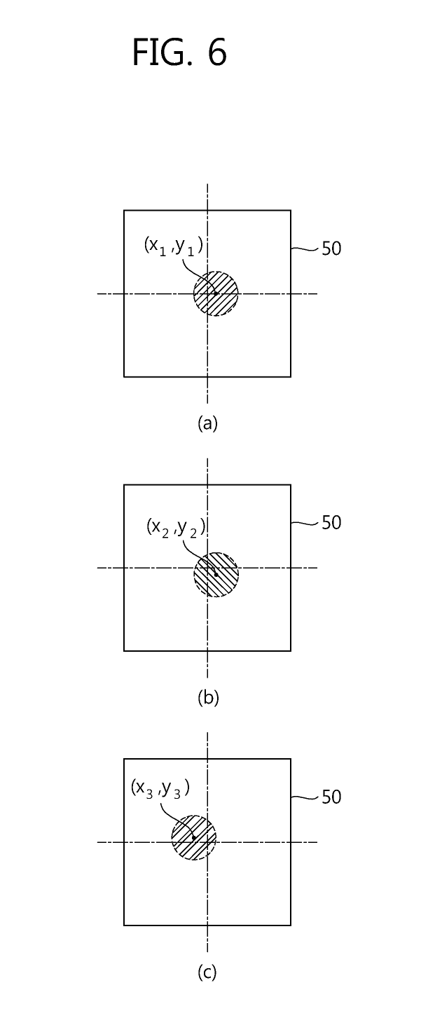

Hereinafter, an application example according to this exemplary embodiment will be described with reference to FIGS. 6 to 8.

First of all, FIG. 6 is a top plan view showing light patterns according to wavelength in FIG. 1. As explained above, the light source according to this exemplary embodiment may be configured to irradiate light of various wavelengths. However, some optical elements of the optical system have different aberrations depending on the wavelength of traveling light. Thus, even when the optical system and the optical medium are at the same position, light patterns detected by the optical detect may differ depending on the wavelength of light irradiated from the light source.

a of FIG. 6 shows a light pattern obtained from the light detector 50 when a red laser beam is irradiated. b of FIG. 6 shows a light pattern obtained from the light detector 50 when a green laser beam is irradiated. c of FIG. 6 shows a light pattern obtained from the light detector 50 when a blue laser beam is irradiated.

As such, a certain amount of difference may be generated between detected light patterns depending light wavelength even if the light beams travel along the same light path. In this case, the controller 60 can calculate compensation values for respective wavelength by analyzing the light patterns for the respective light wavelengths. For example, (x1, y1) can be calculated for the red laser beam, (x2, y2) can be calculated for the green laser beam, and (x3, y3) can be calculated for the blue laser beam.

Accordingly, the controller 60 is able to minimizing differences caused by variations in the wavelength of light irradiated from the light source by storing compensation values for different light wavelengths and then selectively controlling the positions of some optical elements of the optical system 30 depending on the wavelength of the light irradiated from the light source.

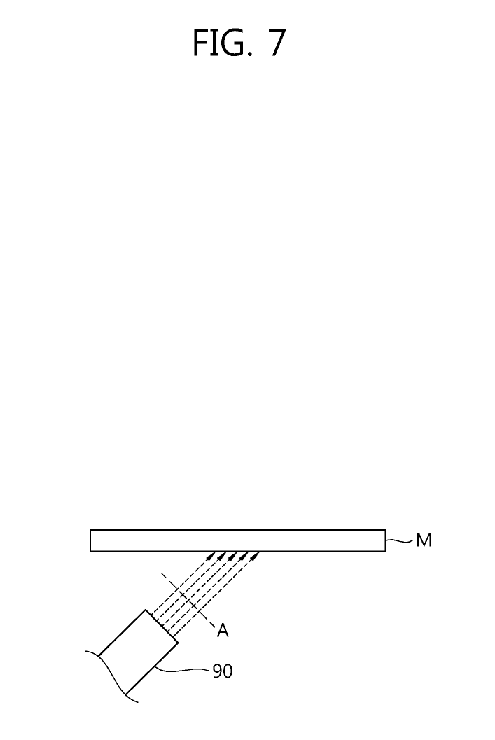

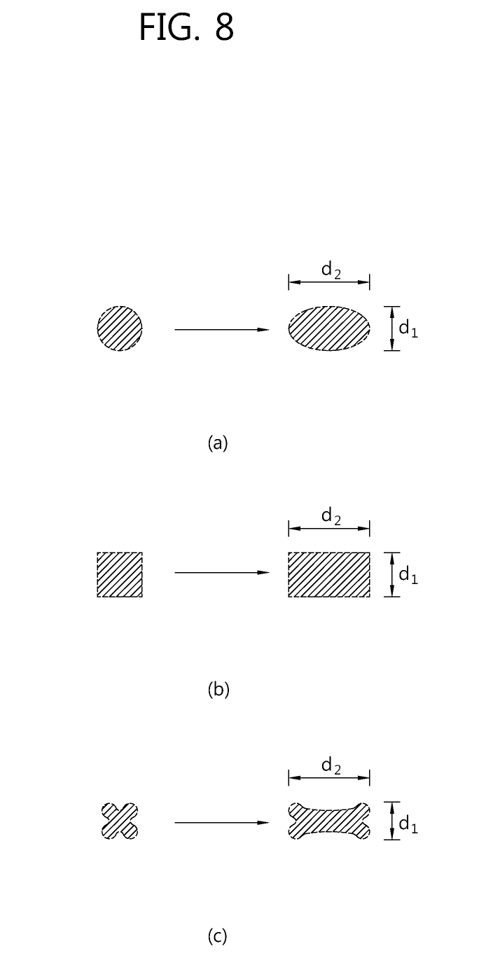

FIG. 7 is a top plan view showing the irradiation of reference light in FIG. 1. FIG. 8 is a cross-sectional view showing a cross-section of irradiation of the reference light of FIG. 7 and a cross-section of irradiation on the optical medium.

As shown in FIG. 7, the optical information processing apparatus 1 may further include a reference light irradiator 90 for irradiating reference light. Information is written on the optical medium such as a holographic storage medium due to light interference. At this point, the reference light is irradiated onto the optical medium M at a predetermined irradiation angle with respect to light irradiated form the light source.

In the case of an optical medium using an angle multiplexing method, information may be written or reproduced at the same position depending on the angle of irradiation of reference light; even in the case that the angle multiplexing method is not used, the intensity of a detected light pattern may differ depending on the irradiation angle. Accordingly, reference light needs to be irradiated onto the optical medium at a predetermined irradiation angle in order to properly operate the optical information processing apparatus, and the optical information processing apparatus according to this exemplary embodiment is able to analyze and compensate the irradiation angle of the reference light by using the pattern of the reference light formed on the light detector 50.

FIG. 8 is a view showing cross-sections of reference light taken at plane A of FIG. 7 and light patterns detected with the reference light. When reference light is irradiated onto the optical medium M, diffused reflection occurs on the optical medium M, and part of the reference light reaches the light detector 50 through the optical system 30. Accordingly, upon irradiation of reference light, the irradiation angle of the reference light can be calculated by using a light pattern detected by the light detector 50.

As shown in a of FIG. 8, when reference light having a circular cross section (the left side of a of FIG. 8) is obliquely irradiated onto the optical medium, a light pattern having an elliptical shape (the right side of a of FIG. 8) is detected. Accordingly, in a similar manner to the description set forth above in FIG. 3, the light pattern has a shape longer in a predetermined direction depending on the irradiation angle of the light. Therefore, it is possible to determine whether the reference light is irradiated at a proper irradiation angle based on the ratio of the long axis d2 and short axis d1 of the ellipse.

Although a of FIG. 8 illustrates an example of irradiation of reference light on a circular cross-section, it is possible to calculate the irradiation angle of the reference light based on the ratio of the long axis and short axis of the light pattern even if the reference light has a cross-section of a particular shape.

Accordingly, the controller 60 calculates the irradiation angle of the reference light by analyzing the detected light pattern, and then if the irradiation angle is different from a predetermined angle, the controller 60 can compensate the irradiation angle by controlling the reference light irradiator 90 by means of a third position adjustment unit (not shown).

As such, according to this exemplary embodiment, the optical medium and the optical system can be aligned, differences caused by different light wavelengths can be compensated for, and the irradiation angle of reference light can be automatically controlled, thereby enabling optical information to be processed accurately.

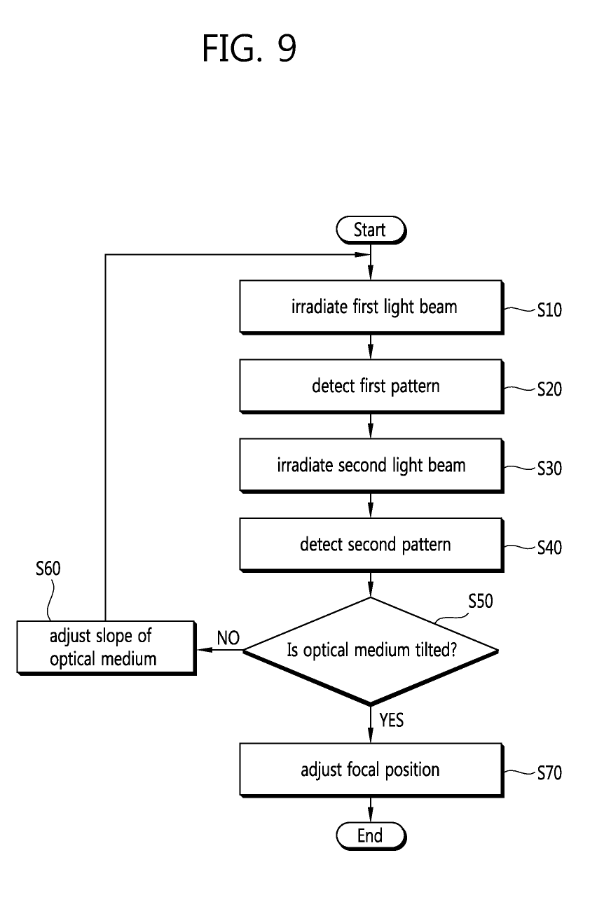

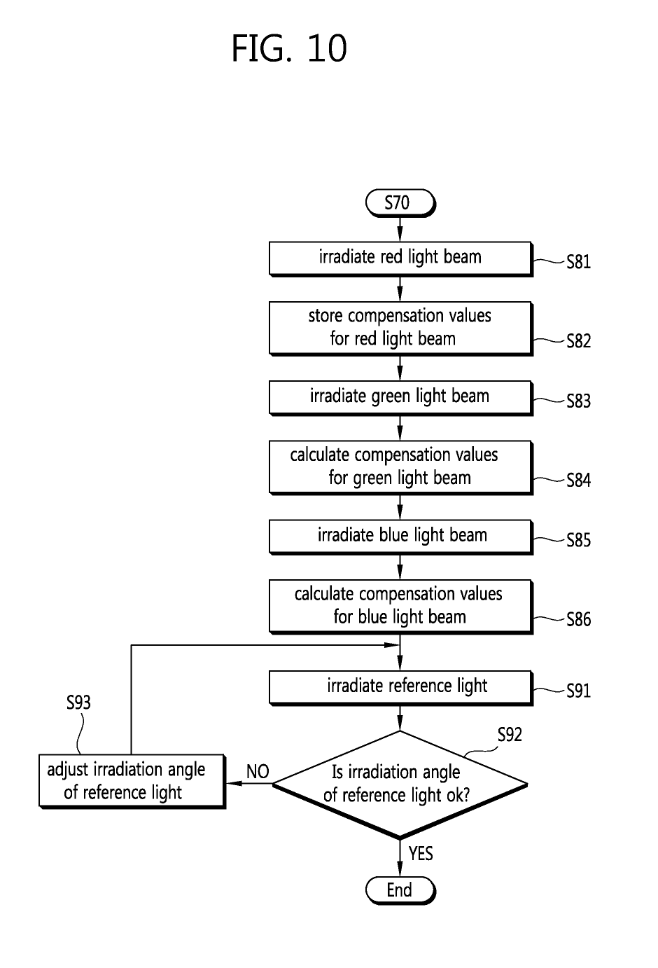

Now, a method for controlling the optical information processing apparatus according to this exemplary embodiment will be described with reference to FIGS. 9 and 10. First of all, FIG. 9 is a sequential chart showing a method for controlling the optical information processing apparatus according to this exemplary embodiment.

First of all, the optical medium M is placed at the first position, and then the light source 10 is driven to irradiate a first light beam (S10). The light beam irradiated from the light source 10 may be a light beam for writing information on the optical medium M, or a light beam for alignment used to measure the aligned state of the optical system or optical medium.

The first light beam irradiated from the light source 10 is reflected on the optical medium M and incident onto the light detector 50, and the light detector 50 detects a first light pattern forming an image on the surface by the first light beam (S20).

Next, the controller 60 controls the second position adjustment unit 80 to shift the optical medium M to the second position and then irradiate a second light beam (S30). As stated above, the second position corresponds to a position spaced apart from the first position by a predetermined distance in a vertical direction. The second d light beam has the same characteristics as the first light beam.

Like the first light beam, the second light beam is reflected on the optical medium and incident onto the light detector 50, and the light detector 50 detects a second light pattern forming an image on the surface by the second light beam (S40).

Although this control method has been described with respect to an example in which a light beam irradiated from the light source is split into first and second light beams, and the light beams are intermittently irradiated depending on the position of the optical medium, the present invention is not limited to the above example, and the optical medium may be shifted while light is continuously irradiated from the light source and the light detector selectively detects a first pattern and a second pattern.

Once the first light pattern and the second light pattern are detected, the controller 60 comparatively analyzes the two patterns and determines whether the optical medium M is tilted or not (S50). If the two light patterns are detected to have the same center position, the optical medium M is deemed as being horizontal. On the other hand, if the optical medium M is detected to be tilted at a predetermined angle, the controller 60 controls the second position adjustment unit 80 to compensate for the slope of the optical medium M (S60), and then acquires two light patterns at different positions and determines whether the slope is properly compensated for.

If the optical medium M is deemed as being horizontal, the controller 60 performs the step S70 of adjusting the focal position while controlling the first position adjustment unit 70 or second position adjustment unit 80, and then finishes its operation.

FIG. 10 is a sequential chart showing another method for controlling the optical information processing apparatus according to this exemplary embodiment. Although FIG. 9 illustrates the step of adjusting the slope and focal position of the optical medium by using light patterns, it is also possible to perform an additional step of calculating compensation values for different wavelengths by the analysis of light patterns and controlling the irradiation angle of reference light, as illustrated in FIG. 10.

For example, after the step S70 of adjusting focal position, the light source irradiates a red laser beam (S81), and then detects a light pattern and calculates and stores compensation coordinates or the red wavelength region (S82). Afterwards, the light source irradiates a green laser beam (S83), and then likewise calculates and stores compensation coordinates for the green wavelength region (S84). Further, the light source irradiates a blue laser beam (S85), and then likewise calculates and stores compensation coordinates for the blue wavelength region (S86).

Accordingly, the controller 60 is able to control the position of the optical system 30, based on the calculated compensation coordinates for each of the wavelengths of the light beams generated from the light source upon driving the optical information processing apparatus 1, thereby minimizing differences caused by different wavelengths.

After the step of calculating compensation coordinates for different wavelengths is finished, the step of aligning the irradiation angle of reference light may be additionally performed. To this end, the reference light irradiator 90 irradiates reference light onto the optical medium (S91). The light detector 50 detects a light pattern formed by the reference light transmitted from the optical medium M. Then, the controller 60 analyzes the irradiation angle of the reference light based on the detected light pattern, and determines whether the irradiation angle of the reference light is identical to a predetermined irradiation angle (S92). If the irradiation angle of the reference light is different from the predetermined irradiation angle, the controller 60 controls the third position adjustment unit to adjust the irradiation angle of the reference light (S93). Next, reference light is irradiated again, and the step of determining whether the irradiation angle of the reference light is identical to the predetermined angle is repeated. As a result, the irradiation angle of the reference light can be accurately aligned.

As explained above, the optical information processing apparatus according to the present exemplary embodiment is able to automatically check the installation state of the optical medium, the aligned state of the optical system, the aligned state of the reference light irradiator, etc based on a light pattern obtained from the light detector, and automatically adjust these states for optimization, thereby minimizing the occurrence of errors upon driving the optical information processing apparatus.

It is to be noted that although FIGS. 9 and 10 merely illustrate an example of controlling the optical information processing apparatus according to the present invention, the invention can be modified in various forms without departing from the technical spirit of the invention.

1. An optical information processing apparatus comprising:
a light source for irradiating light;
an light modulator for modulating the light irradiated from the light source;
an optical system for focusing the light modulated by the light modulator and allowing the focused light to be incident on an optical medium;
a stage where the optical medium is situated;
a light detector for detecting a pattern of light reflected on the optical medium; and
a controller that analyzes the light pattern detected by the light detector and controls the position of the optical system or the stage.

2. The optical information processing apparatus of claim 1, wherein the light detector detects light patterns at first and second positions, and the controller controls the position of the optical system or the stage by comparing the positions, sizes, or intensity distributions of the light patterns at the first and second positions, and
wherein the positions of the optical medium or the positions of one of a plurality of elements of the optical system at the first and second position are respectively different.

3. The optical information processing apparatus of claim 2, wherein the second position corresponds to a position of the stage spaced apart from the first position by a predetermined distance along the optical axis.

4. The optical information processing apparatus of claim 3, wherein if the centers of the light patterns at the first and second positions detected by the light detector are identical, the controller determines that the stage is properly aligned along the optical axis.

5. The optical information processing apparatus of claim 3, wherein the controller analyzes the positions of the centers of the light patterns at the first and second positions detected by the light detector and an amount of change in the position of a given feature point between the patterns to determine whether the stage is tilted or not.

6. The optical information processing apparatus of claim 2, further comprising:
a first position adjustment unit for controlling the position of at least one of a plurality of optical elements of the optical system; and
a second position adjustment unit for adjusting the angle of slope of the stage.

7. The optical information processing apparatus of claim 6, wherein the controller controls the first position adjustment unit or the second position adjustment unit to control at least one of the focal position, spot size, irradiation angle, and intensity distribution of light irradiated onto the optical medium.

8. The optical information processing apparatus of claim 3, further comprising:
a first polarizing beam splitter that reflects light incident from the light source in the direction of the light modulator and passes light incident from the light modulator therethrough in the direction of the optical system; and
a second polarizing beam splitter that passes light incident onto the optical medium therethrough and reflects light reflected and incident from the optical medium in the direction of the light detector.

9. The optical information processing apparatus of claim 1, wherein the light source is configured to generate at least two light beams having different wavelengths, and the controller analyzes the respective light patterns detected by the light detector by the light beams of different wavelengths, and calculates compensation coordinates for the different wavelengths.

10. The optical information processing apparatus of claim 1, further comprising a reference light irradiator for irradiating reference light onto the optical medium,
the controller being configured to calculate the irradiation angle of the reference light by using the shape of a light pattern formed by the reference light.

11. A method for controlling an optical information processing apparatus, the method comprising the steps of:
irradiating light modulated through a light modulator onto an optical medium through an optical system;
detecting a pattern of light reflected from the optical medium;
analyzing the light pattern detected in the step of detecting a light pattern; and
adjusting the position of the optical system or the optical medium based on information obtained in the analysis step.

12. The method of claim 11, wherein the detection of a light pattern comprises: a first detection step of detecting a pattern of light reflected from the optical medium at a first position; and a second detection step of detecting a pattern of light reflected from the optical medium at a second position, and
wherein the positions of the optical medium or the positions of one of a plurality of elements of the optical system at the first and second position are respectively different.

13. The method of claim 12, wherein, in the second detection step, the optical medium is positioned, shifted from the position of the first detection step by a predetermined distance in the light travel direction.

14. The method of claim 12, wherein, in the analysis step, if the center of the light pattern at the first position detected in the first detection step and the center of the light pattern at the second position detected in the second detection step are identical, the optical medium is determined as being properly aligned along the optical axis.

15. The method of claim 12, wherein, in the analysis step, the positions of the centers of the light patterns at the first and second positions detected in the first and second detection steps and an amount of change in the position of a given feature point between the patterns are analyzed to determine whether the optical medium is tilted or not.

16. The method of claim 12, wherein, in the position adjustment step, the position of the optical system or the optical medium is adjusted to control at least one of the focal position, spot size, irradiation angle, and intensity distribution of light irradiated onto the optical medium.

17. The method of claim 16, wherein, in the position adjustment step, based on the information obtained in the analysis step, the position of at least one of a plurality of optical elements of the optical system is controlled, or the angle of slope of the stage where the optical medium is situated is adjusted.

18. The method of claim 11, wherein, in the light irradiation step, light beams of different wavelengths are sequentially irradiated,
in the light pattern detection step, light patterns formed by the light beams of different wavelengths are detected, and
in the analysis step, compensation coordinates are calculated for each of the different wavelengths.

19. The method of claim 11, further comprising the steps of:
driving a reference light irradiator to irradiate reference light onto the optical medium;
detecting a reference light pattern formed on a light detector by the reference light; and
calculating the irradiation angle of the reference light by using the reference light pattern.
